(19) United States
(12) Patent Application Publication
(10) Pub. No.: US 2017/0194080 A1
(43) Pub. Date: Jul. 6, 2017

(54) GROMMET

(71) Applicant: NOK Corporation, Tokyo (JP)

(72) Inventor: Suguru NARA, Kumamoto (JP)

(73) Assignee: NOK Corporation, Tokyo (JP)

(21) Appl. No.: 15/308,726

(22) PCT Filed: Jul. 10, 2015
(86) PCT No.: PCT/JP2015/069906

§ 371 Date: Nov. 3, 2016

(30) Foreign Application Priority Data
Jul. 22, 2014 (JP) 2014-149178

(51) Int. Cl. H01B 17/58; H01B 3/28

(52) U.S. Cl. CPC H01B 17/583; H01B 3/28

(57) ABSTRACT

The object is to suppress deformation and secure sealing properties even if a wire is bent in the vicinity of a grommet, and the object is resolved by a grommet G1 comprising a grommet main body 1 made of a rubber elastic material and having a throughhole 2 disposed therein into which a wire 6 is inserted and a rigid plate 4 made of a material with a less deformation quantity than that of the grommet main body 1 and having an opening 3 disposed therein through which the wire 6 inserted into the throughhole 2 can be drawn out, in which the rigid plate 4 is disposed integrally on one end surface of the grommet main body 1 at which the throughhole 2 opens.

### FIELD OF THE INVENTIONS

The present invention relates to a grommet, and more particularly, to a grommet capable of keeping its sealing properties even when a wire inserted into the grommet is bent.

### BACKGROUND OF THE INVENTIONS

Conventionally, at the time of connecting a wire to an electric device such as a connector, a grommet made of a rubber elastic material is used as a wire sealing material (Patent Document 1).

The grommet shown in Patent Document 1 will be described with reference to FIGS. 8 and 9. FIG. 8 is a partially cutout perspective view of the grommet and each of FIGS. 9(a) and 9(b) is a cross-sectional view of a state of usage of the grommet shown in FIG. 8.

This grommet has plural throughholes 200 bored in the vicinity of the center of a grommet 100 made of the rubber elastic material. A sealing ring part 110 is disposed on the outer periphery of the grommet 100. A ring-shaped convex part 210 is formed inside the throughhole 200.

When a wire 600 is inserted into the throughhole 200 of this grommet 100, sealing properties are secured by the wire 600 coming into close contact with the ring-shaped convex part 210 inside the throughhole 200. As shown in FIG. 9, when the grommet 100 is crushed to be mounted and fixed to a predetermined mounting part 500 of the connector, etc., the sealing properties are secured between the sealing ring part 110 and the mounting part 500.

### PRIOR ART DOCUMENT

### Patent Document

Patent Document 1: JP-A-2007-299665

### SUMMARY

### Problem to be Solved by the Invention

By the way, the wire 600 can possibly be bent in the vicinity of the grommet 100 mounted to the mounting part 500. In this case, in response to the bending of the wire 600, the grommet 100 itself is deformed. As a result, as shown in an enlarged cross-sectional view of a part A encircled by a chain double-dashed line in FIG. 9(b), there is a problem that the degree of adhesion between the sealing ring part 110 and the mounting part 500 is impaired, with the sealing properties degraded. Further, in response to the bending of the wire 600, the throughhole 200 as well is deformed to have an enlarged diameter. As a result, as shown in an enlarged cross-sectional view of a part B encircled by the chain double-dashed line in FIG. 9(b), a problem arises that the degree of adhesion between the ring-shaped convex part 210 and the wire 600 is impaired, with the sealing properties degraded.

Therefore, the object of the present invention is to provide a grommet capable of suppressing a deformation of the grommet and securing sealing properties even if a wire is bent in the vicinity of the grommet.

Other objects of the present invention will become obvious from the following description.

### Means for Solving Problem

The above problems can be solved by each of the following inventions.

1. A grommet comprising:

a grommet main body made of a rubber elastic material and having a throughhole disposed therein into which a wire is inserted; and

a rigid plate made of a material with a less deformation quantity than that of the grommet main body and having an opening disposed therein through which the wire inserted into the throughhole can be drawn out, wherein

the rigid plate is disposed integrally on one end surface of the grommet main body at which the throughhole opens.

2. The grommet according to 1, wherein

the opening is arranged at the position corresponding to the throughhole as well as being formed larger than the throughhole, and wherein

such a sleeve is disposed inside the opening that is made of the rubber elastic material to prevent the contact between the inner surface of the opening and the wire inserted into the throughhole.

3. The grommet according to 1 or 2, wherein

the rigid plate is 1 mm to 3 mm thick.

4. The grommet according to 1, 2, or 3, wherein the rigid plate has a rib on its surface in contact with the grommet main body.

5. The grommet according to any one of 1 to 4, wherein

the rigid plate is disposed integrally with the grommet main body by molding, bonding, or fusing.

### EFFECT OF THE INVENTION

According to the present invention, it is made possible to provide a grommet capable of suppressing a deformation of the grummet and securing sealing properties even if a wire is bent in the vicinity of the grommet.

### BRIEF DESCRIPTION OF THE DRAWINGS

FIG. 1 is a perspective view of an embodiment of a grommet according to the present invention.

FIG. 2 is a partially cutout perspective view of the grommet shown in FIG. 1.

FIG. 3 is a longitudinal cross-sectional view of the grommet shown in FIG. 1.

FIG. 4 is an enlarged cross-sectional view of a state of usage of the grommet shown in FIG. 1.

FIG. 5(a) is a perspective view of another embodiment of the grommet according to the present invention and FIG. 5(b) is a partially cutout perspective view thereof.

FIG. 6 is a cross-sectional view of a further embodiment of the grommet according to the present invention.

FIG. 7 is a cross-sectional view of a still further embodiment of the grommet according to the present invention.

FIG. 8 is a partially cutout perspective view of a conventional grommet.

Each of FIG. 9(a) and FIG. 9(b) is a cross-sectional view of a state of usage of the grommet shown in FIG. 8.

### DETAILED DESCRIPTION OF THE INVENTIONS

Embodiments of the present invention will now be described with reference to drawings.

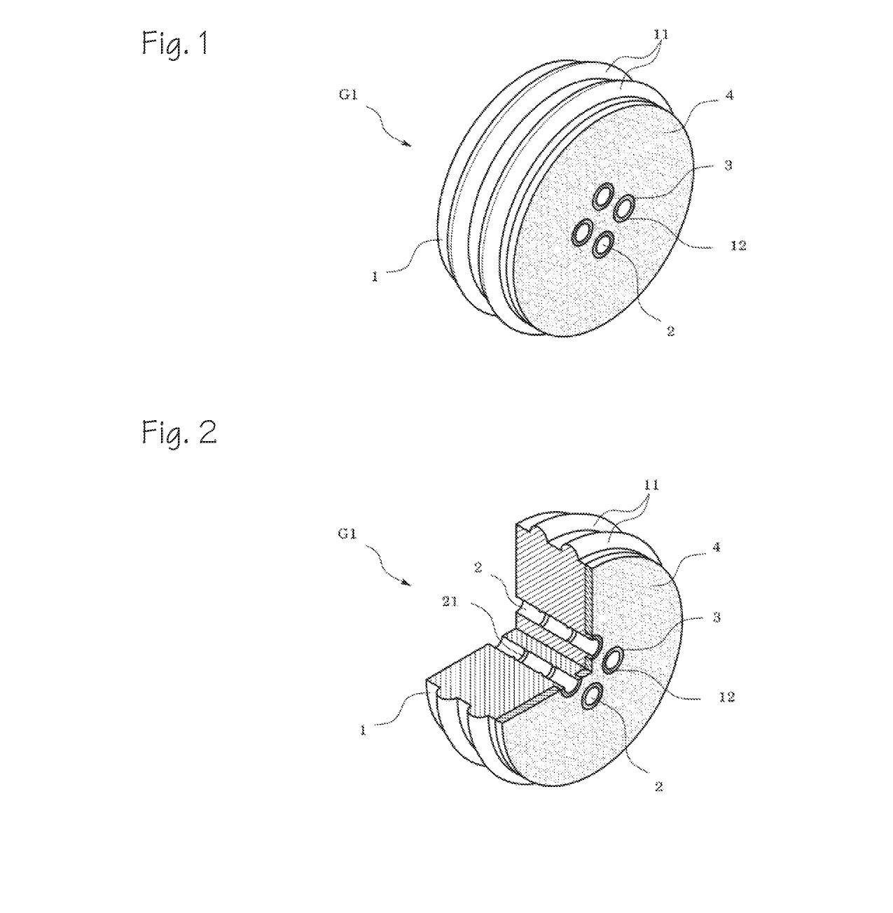

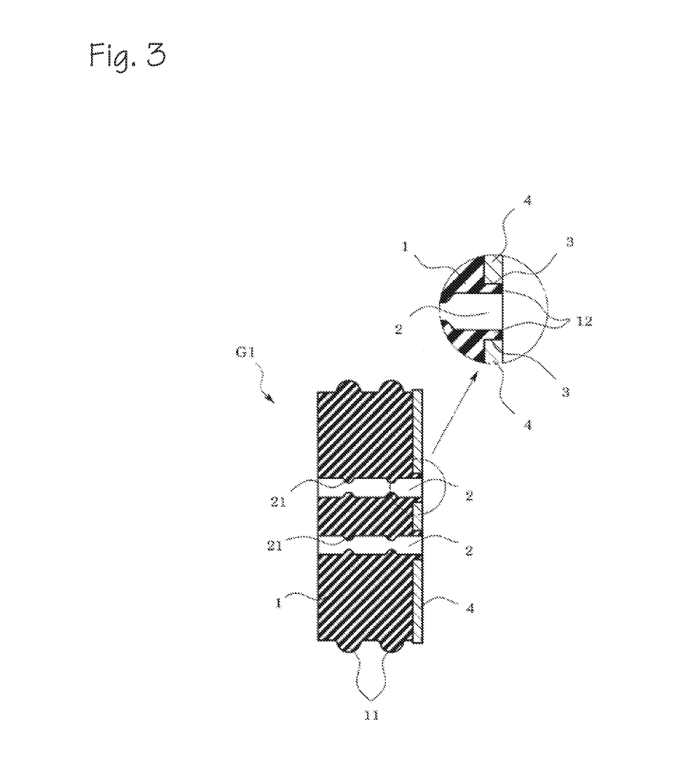

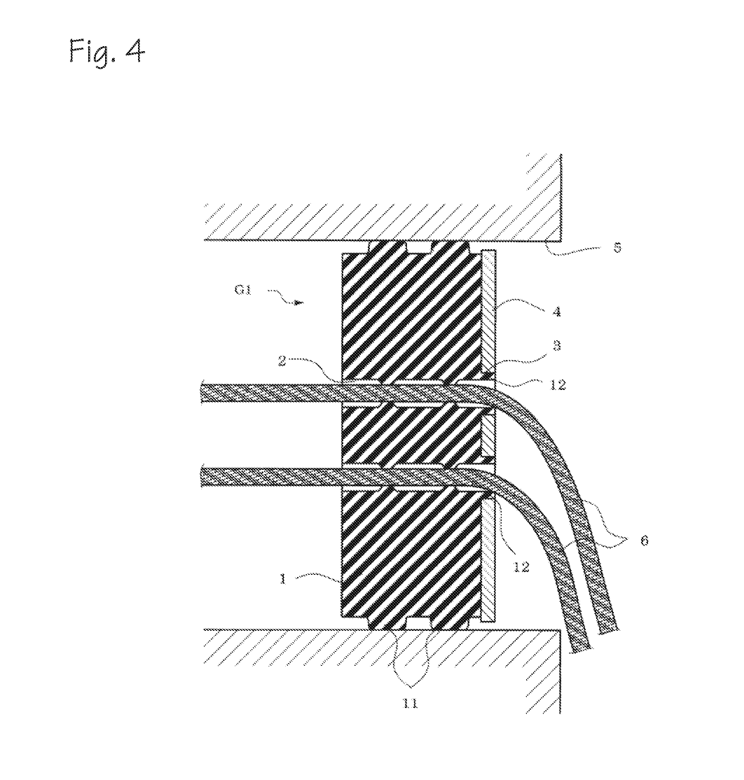

FIG. 1 is a perspective view of an embodiment of a grommet according to the present invention, FIG. 2 is a partially cutout perspective view of the grommet shown in FIG. 1, FIG. 3 is a longitudinal cross-sectional view of the grommet shown in FIG. 1, and FIG. 4 is an enlarged cross-sectional view of a state of usage of the grommet shown in FIG. 1.

A grommet G1 is composed of a grommet main body 1 and a rigid plate 4. The grommet main body 1 has a throughhole 2 disposed therein. The rigid plate 4 is disposed integrally on one end surface of the grommet main body 1 at which the throughhole 2 opens.

The grommet main body 1 is made of a rubber elastic material of, for example, silicone rubber, fluororubber (FKM), etc. Two rows of sealing ring parts 11 are protruded integrally on the outer periphery of the grommet main body 1. When the grommet main body 1 is crushed to be mounted to a predetermined mounting part 5 of a connector, etc., this sealing ring part 11 has a role of elastically contacting closely the inner surface of the mounting part 5 and securing sealing properties between the sealing ring part 11 and the mounting part 5.

While the grommet main body 1 shown in this embodiment is formed in a cylindrical shape, there is no limitation to the specific shape thereof. The shape of the grommet main body 1 is formed so as to match the shape of the mounting part 5 and for example, may be other shape such as a rectangle with corners rounded, depending on the shape of the mounting part 5.

The throughhole 2 is a hole for inserting and fixing a wire 6 to be described later. While in this embodiment, four throughholes 2 are disposed in the vicinity of the center of the grommet main body 1, there is no limitation to the number and the arrangement form of the throughholes 2. While the throughhole 2 shown in this embodiment is formed to have a cross-section of a circular shape, there is no limitation to the shape and the throughhole 2 can be made to have an appropriate cross-sectional shape depending on the cross-sectional shape of the wire 6 to be inserted. When plural throughholes 2 are disposed, the cross-sectional shape and the size of the throughhole 2 may be the same for all throughholes 2 or may include a different shape or size.

As shown in FIGS. 2 and 3, a ring-shaped convex part 21 is formed integrally on the inner surface of the throughhole 2. The ring-shaped convex part 21 has a role of fixing the wire 6 by the elasticity of the rubber elastic material as well as securing the sealing properties between the wire 6 and the throughhole 2 when the wire 6 is inserted into the throughhole 2. From a viewpoint of making the fixing of the wire 6 and the securing of the sealing properties more secure, it is preferable to have plural ring-shaped convex parts 21 disposed at intervals in the axial direction of the throughhole 2, as shown in this embodiment.

The rigid plate 4 is formed of a material having a less deformation quantity than that of the grommet main body 1 when stress is applied to the grommet G1. Namely, the rigid plate 4 has higher rigidity that that of the grommet main body 1. This rigid plate 4 has a role of suppressing the deformation of the grommet main body 1 by being disposed integrally on the end surface of the grommet main body 1.

The quality of the material of the rigid plate 4 does not matter so long as the material has higher rigidity that that of the grommet main body 1 and for example, a metal plate such as an aluminum plate, a copper plate, and a stainless steel plate and a ceramic plate can be used. It is preferable to use a synthetic resin plate of polybutylene terephthalate (PBT), polyamide (PA), etc. In the case of using the metal plate as the rigid plate 4, to achieve insulation with the wire 6 to be inserted into the throughhole 2, a coated wire is used for the wire 6.

The rigid plate 4 is formed in the same circular shape as the shape of the end surface of the grommet main body 1. As to the size of the rigid plate 4, it is preferable for the rigid plate 4 to have a size slightly smaller than an opening shape of the mounting part 5 and slightly larger than the outer periphery of the grommet main body 1 excluding the sealing ring part 11, as shown in FIGS. 3 and 4. By this, at the time of mounting this grommet G1 to the mounting part 5, the grommet G1 can be mounted easily by pinching the rigid plate 4. Even if stress is applied to the grommet main body 1 when the wire 6 is bent, the grommet main body 1 can be prevented from being excessively deformed since the outer peripheral edge of the rigid plate 4 abuts against the mounting part 5.

The rigid plate 4 has an opening 3 disposed therein. The opening 3 is intended for the purpose of drawing the wire inserted into the throughhole 2 of the grommet main body 1 out of this opening 3 toward the surface of the rigid plate 4. Since the throughhole 2 shown in this embodiment has the cross-section of the circular shape, the opening 3 as well is formed to have the circular shape.

In this embodiment, the rigid plate 4 has four openings 3 disposed therein, the same number as the number of the throughholes 2 of the grommet main body 1. The openings 3 are arranged at the positions respectively corresponding to the throughholes 2 of the grommet main body 1. This makes it possible to effectively suppress the deformation in the vicinity of each throughhole 2 by the rigid plate 4. Each opening 3 is formed to open largely than its corresponding throughhole 2.

The opening 3 is arranged so that the wire 6 inserted into the throughhole 2 can be drawn out toward the surface of the rigid plate 4. Namely, the opening 3 is arranged so that the peripheral edge of the opening 3 will not come inside the opening of the throughhole 2. From the viewpoint of enhancing the insertion property of the wire 6, it is preferable to have the throughhole 2 and the opening 3 arranged concentrically.

The inside of the opening 3 formed more largely than the throughhole 2 may be a space part in which nothing exists but it is preferable to have a sleeve 12 made of the rubber elastic material disposed inside the opening 3, as shown in FIG. 3. The sleeve 12 is formed of the rubber elastic material to have a hollow tubular shape and covers the inner surface of the opening 3. The inside of the sleeve 12 is communicated with the throughhole 2 of the grommet main body 1. Therefore, this grommet G1 can have the wire 6 drawn out through the throughhole 2 and the sleeve 12 toward the surface of the rigid plate 4.

This sleeve 12 prevents the wire 6 inserted into the throughhole 2 of the grommet main body 1 from coming into contact with the inner surface of the opening 3. Namely, when the wire 6 is bent, the wire 6 is in contact with the sleeve 12 but is not in contact with the rigid plate 4. This makes it possible to reduce the load on the wire 6 and to achieve protection of the wire 6. Even if the wire 6 is not a coated wire, a metal plate can be used as the rigid plate 4.

The sleeve 12 shown in this embodiment has its outer end surface formed to be flush with the surface of the rigid plate 4. From a viewpoint of more effectively preventing the contact between the rigid plate 4 and the wire 6, however, it is preferable to have the outer end surface of the sleeve 12 formed to protrude from the surface of the rigid plate 4.

The sleeve 12 can be formed separately from or integrally with the grommet main body 1. For example, to make the protection of the wire 6 more secure, the sleeve 12 as a separate body from the grommet main body 1 can be formed of the rubber elastic material softer than that of the grommet main body 1. The sleeve 12 as the separate body from the grommet main body 1 can be disposed at the opening 3 of the rigid plate 4, integrally with the rigid plate 4, by molding, bonding, or fusing, etc.

On the other hand, the sleeve 12 integral with the grommet main body 1 is formed by the rubber elastic material forming the grommet main body 1 penetrating the inside of the opening 3, passing through the inside of the opening 3, and extending up to the surface of the rigid plate 4. The grommet G1 shown in this embodiment represents the case of the sleeve 12 being formed of the rubber elastic material integral with that of the grommet main body 1. The throughhole 2 opens at the end surface of this sleeve 12. Since the sleeve 12 integral with the grommet main body 1 is molded concurrently with the molding of the grommet main body 1, a manufacturing process can be simplified.

The molding, the bonding, or the fusing, etc., can be cited as a method of integrally disposing the rigid plate 4 on the end surface of the grommet main body 1. From a viewpoint of simplifying the manufacturing process, it is preferable to install the rigid plate 4 inside a molding mold of the grommet main body 1 and mold the grommet main body 1 and the rigid plate 4 integrally.

The rigid plate 4 should preferably be 1 mm to 3 mm thick. A thinner thickness will decrease the strength and degrade the molding property. A thicker thickness will give enough strength but will make the grommet G1 as a whole rigid and hard to treat.

Operation and effect of the grommet G1 will now be described.

The grommet G1, with the wire 6 inserted into the throughhole 2 drawn out of the opening 3 toward the surface of the rigid plate 4, is mounted inside the mounting part 5 so that the rigid plate 4 will face outward.

After the mounting, when the wire 6 is bent as shown in FIG. 4, the stress by the bending of the wire 6 is applied firstly to the rigid plate 4 and then to the grommet main body 1 by way of this rigid plate 4. By this, the grommet main body 1 starts to be deformed. However, the rigid plate 4, which is hard to deform as compared with the grommet main body 1, functions to suppress the deformation of the grommet main body 1. Since there is no large deformation of the grommet main body 1, the grommet G1 is stably held at a predetermined position of the mounting part 5.

Generally, as to the measures of suppressing the deformation of the grommet by the wire bending, there is a method of elongating the grommet. This method, however, requires a wide expansion of space. By contrast, this grommet G1 can suppress the deformation of the grommet main body 1 by the rigid plate 4 and therefore, there is no need at all for the elongated formation of the grommet main body 1.

Thus, since the deformation of the grommet main body 1 is suppressed by the rigid plate 4, the amount of crushing of the grommet main body 1 can appropriately be secured and the degree of adhesion between the sealing ring part 11 and the mounting part 5 can be secured. For this reason, the generation of a gap is prevented between the sealing ring part 11 and the inner surface of the mounting part 5 and the sealing properties are secured. Further, also in the inside of the throughhole 2 into which the wire 6 is inserted, since the degree of adhesion is maintained between the ring-shaped convex part 21 and the wire 6, the generation of the gap is prevented between the ring-shaped convex part 21 and the wire and the sealing properties are secured.

As to the measures of enhancing the sealing properties with respect to the bending of the wire, there are a method of heightening the hardness of the rubber elastic material making up the grommet to make the grommet hard-to-deform and a method of increasing a tightening force against the wire. These methods, however, make it hard to insert the wire and make it hard to mount the grommet to the mounting part. By contrast, since this grommet G1 has the deformation of the grommet main body 1 suppressed by the rigid plate 4, there is no need at all for the hardening of the grommet main body 1 or the increasing of the tightening force against the wire 6.

As described above, according to this grommet G1, it is made possible to suppress the deformation of the grommet G1 and to secure good sealing properties, even if the wire 6 is bent in the vicinity of the grommet G1.

As shown in this embodiment, when the sleeve 12 of the grommet main body 1 is formed inside the opening 3, the bent wire 6 comes into contact with the sleeve 12 made of the rubber elastic material. The sleeve 12 upon contacting the wire 6 is crushed and, by absorbing the stress due to the bending of the wire 6 and reducing the load on the wire 6, can protect the wire 6.

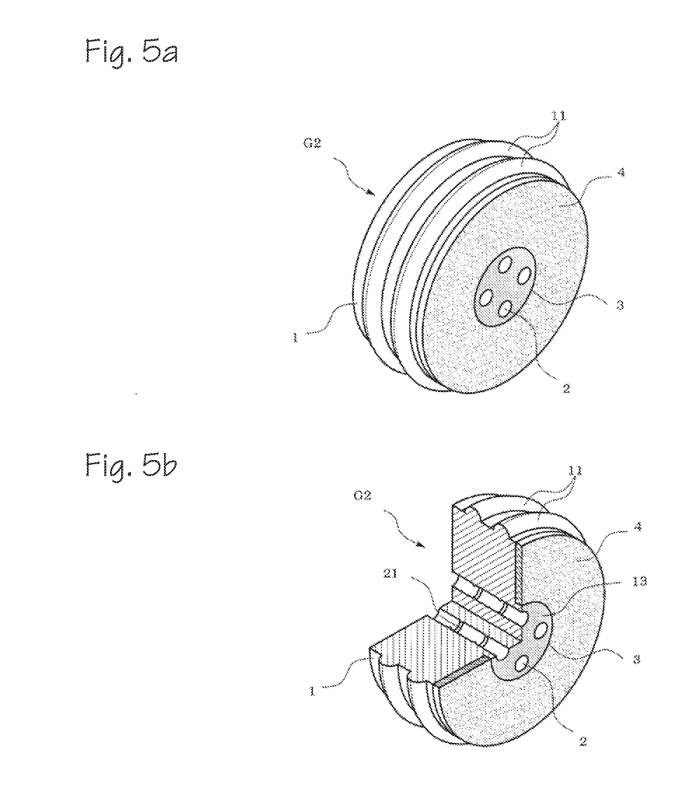

FIG. 5(a) is a perspective view of another embodiment of the grommet according to the present invention and FIG. 5(b) is a partially cutout perspective view thereof. A part with the same reference numeral as that of the grommet shown in FIGS. 1 to 4 is the part of the same configuration and therefore, a detailed description thereof is omitted here, with the above description applied.

A grommet G2 shown in FIG. 5 has one opening 3 disposed in the rigid plate 4. All of the plural throughholes 2 formed in the grommet main body 1 are arranged inside this one opening 3.

The opening 3 is formed to have a circular opening shape but can be formed to have an appropriate opening shape, depending on the arrangement form of the plural throughholes 2.

The inside of the opening 3 may be a space part in which nothing exists but from a viewpoint of preventing the contact between the inner surface of the opening 3 and the wire 6, it is preferable to have a protruding part 13 disposed therein that is made of the rubber elastic material integral with that of the grommet main body 1, as shown in this embodiment. The protruding part 13 is formed to protrude and is fitted to the opening 3 by a central part of the end surface of the grommet main body 1 rising up with the same planar shape as that of the opening 3. All throughholes 2 open at the end surface of the protruding part 13.

This grommet G2 has the same effect as that of the grommet G1 shown in FIGS. 1 to 4.

The grommet G2 according to this embodiment has all of the four throughholes 2 arranged inside one opening 3. According to this, at the time of integrating the rigid plate 4 with the grommet main body 1, the positioning of the throughhole 2 and the opening 3 can be made simplest. The arrangement is not limited to this but it may be so arranged that plural openings 3 are disposed in the rigid plate 4 and that plural throughholes 2 are arranged inside each opening 3. In this case as well, it is preferable to have the protruding part 13 made of the rubber elastic material integral with that of the grommet main body 1 integrally disposed inside each opening 3.

FIG. 6 is a cross-sectional view of a further embodiment of the grommet according to the present invention. A part with the same reference numeral as that of the grommet shown in FIGS. 1 to 4 is the part of the same configuration and therefore, a detailed description thereof is omitted here, with the above description applied.

This grommet G3 is the same as the grommet G1 shown in FIGS. 1 to 4 in that the same number of openings 3 as the number of the throughholes 2 of the grommet main body 1 are disposed in the rigid plate 4. In this grommet G3, however, the opening 3 of the rigid plate 4 has the same opening shape and almost the same size as that of the throughhole 2 of the grommet main body 1 and is formed to be communicated with the throughhole 2.

In this grommet G3 as well, because of the rigid plate 4, the effect can be obtained of suppressing the deformation of the grommet main body 1 and of securing the sealing properties. When the wire 6 (not shown in FIG. 6) inserted into the throughhole 2 and the opening 3 is bent, the effect is the highest of suppressing the deformation of the throughhole 2. Therefore, in particular, the stress applied to the ring-shaped convex part 21 is further reduced and the sealing properties inside the throughhole 2 are further heightened.

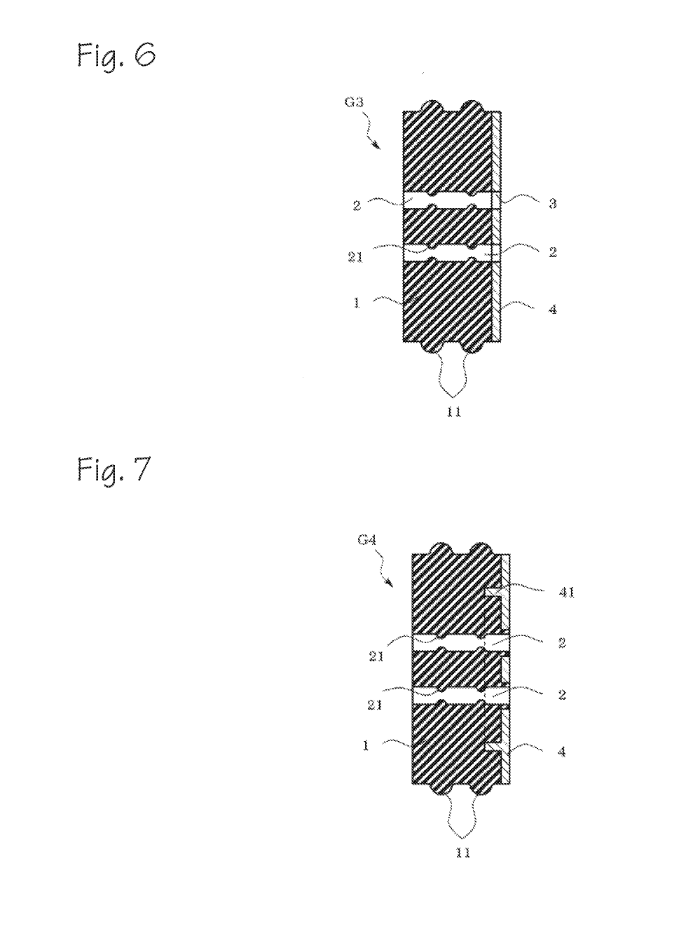

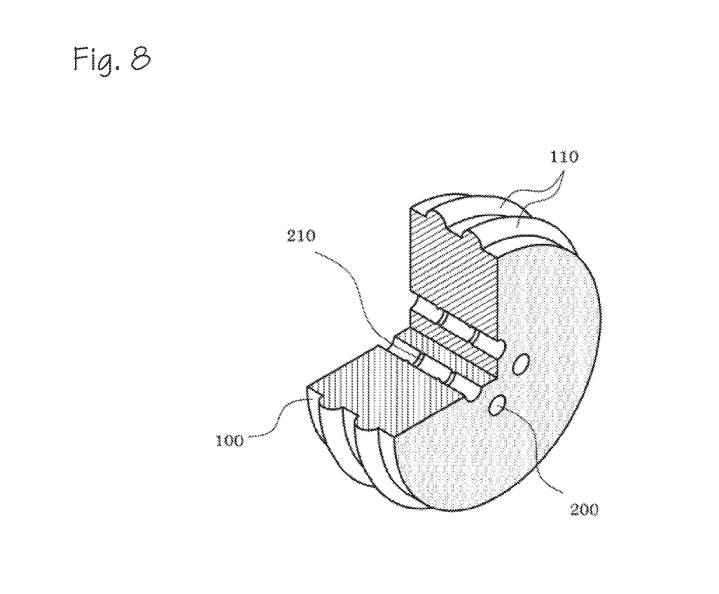

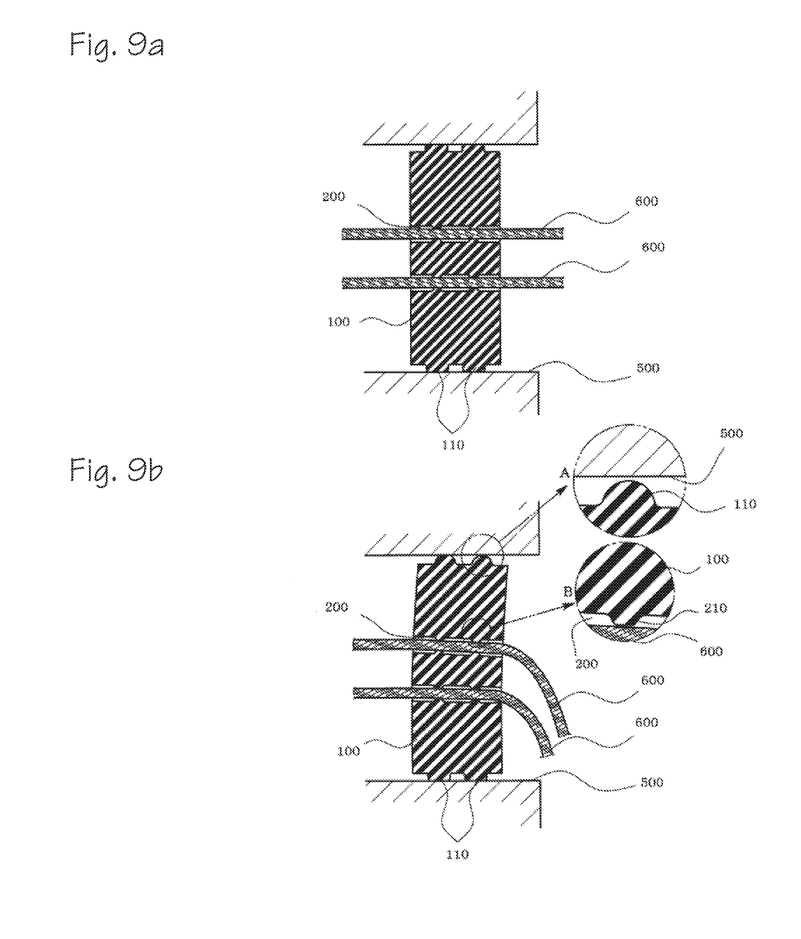

FIG. 7 is a cross-sectional view of a still further embodiment of the grommet according to the present invention. A part with the same reference numeral as that of the grommet shown in FIGS. 1 to 4 is the part of the same configuration and therefore, a detailed description thereof is omitted here, with the above description applied.

In this grommet G4, the rigid plate 4 has, on its surface in contact with the grommet main body 1, a rib 41 integrally formed to protrude. The rib 41 is arranged at the position not interfering with the throughhole 2 of the grommet main body 1. The rib 41 is not limited to any particular shape but can be formed in an annular shape, a radial shape, etc.

The rigid plate 4 with the rib 41 has an increased area of contact with the grommet main body 1 and a heightened degree of adhesion. The rib 41 can provide the rigid plate 4 itself with strength. This makes it possible to form the rigid plate 4 thinner. This grommet G4 can preferably be applied in particular when the grommet main body 1 and the rigid plate 4 are integrated by the molding.

While the grommet G4 shown in FIG. 7 represents the mode of the rigid plate 4 of the grommet G1 shown in FIGS. 1 to 4 being provided with the rib 41, it goes without saying that the rigid plate 4 of the grommets G2 and G3 according to other embodiments may be provided with the rib 41.

### EXPLANATIONS OF LETTERS OR NUMERALS

1: grommet main body

11: sealing ring part

12: sleeve

13: protruding part

2: throughhole

21: ring-shaped convex part

3: opening

4: rigid plate

41: rib

5: mounting part

6: wire

G1 to G4: grommet

1. A grommet comprising:
a grommet main body made of a rubber elastic material and having a throughhole disposed therein into which a wire is inserted; and
a rigid plate made of a material with a less deformation quantity than that of the grommet main body and having an opening disposed therein through which the wire inserted into the throughhole can be drawn out, wherein
the rigid plate is disposed integrally on one end surface of the grommet main body at which the throughhole opens.

2. The grommet according to claim 1,
wherein the opening is arranged at the position corresponding to the throughhole as well as being formed larger than the throughhole, and
wherein such a sleeve is disposed inside the opening that is made of the rubber elastic material to prevent the contact between the inner surface of the opening and the wire inserted into the throughhole.

3. The grommet according to claim 1,
wherein the rigid plate is 1 mm to 3 mm thick.

4. The grommet according to claim 1,
wherein the rigid plate has a rib on its surface in contact with the grommet main body.

5. The grommet according to claim 1,
wherein the rigid plate is disposed integrally with the grommet main body by molding, bonding, or fusing.

6. The grommet according to claim 2,
wherein the rigid plate is 1 mm to 3 mm thick.
